(19) United States
(12) Patent Application Publication
(10) Pub. No.: US 2026/0008450 A1
(43) Pub. Date: Jan. 8, 2026

(54) HYBRID ELECTRIC VEHICLE AND A CONTROL METHOD THEREOF

(71) Applicants: HYUNDAI MOTOR COMPANY, Seoul (KR); KIA CORPORATION, Seoul (KR)

(72) Inventor: Jun Woo Jeon, Hwaseong-si (KR)

(73) Assignees: HYUNDAI MOTOR COMPANY, Seoul (KR); KIA CORPORATION, Seoul (KR)

(21) Appl. No.: 19/200,285

(22) Filed: May 6, 2025

(30) Foreign Application Priority Data
Jul. 3, 2024 (KR) 10-2024-0087788

(51) Int. Cl. B60W 20/19; B60W 10/02; B60W 10/06; B60W 10/08

(52) U.S. Cl. CPC B60W 20/19; B60W 10/02; B60W 10/06; B60W 10/08; B60W 2510/0647; B60W 2510/0657; B60W 2552/15; B60W 2552/30; B60W 2556/10; B60W 2556/50; B60W 2710/021; B60W 2710/0638; B60W 2710/0683; B60W 2710/083

(57) ABSTRACT

Disclosed are a hybrid electric vehicle and a control method thereof. In particular, the hybrid electric vehicle includes: an engine with a supercharger using exhaust gas; a driving motor; and a controller configured to determine whether entry into an acceleration state accompanied by turbo lag of the engine is expected while the engine operates, increase boost pressure of the supercharger before entering the acceleration state when it is determined that the entry into the acceleration state is expected, and control a torque of the driving motor to offset an engine torque of the engine that is increased to increase the boost pressure.

### CROSS REFERENCE TO RELATED APPLICATION

This application claims priority to Korean Patent Application No. 10-2024-0087788, filed Jul. 3, 2024, the entire contents of which are incorporated herein by reference.

### BACKGROUND

### Field

The disclosure relates to a hybrid electric vehicle having an engine with a supercharger and a control method for the hybrid electric vehicle.

### Description of the Related Art

With recent increasing interest in the environment, electrified vehicles using an electric motor (or a driving motor) as a power source have been emerging. As an example of the electrified vehicles, there are electric vehicles (EV), hybrid electric vehicles (HEV), fuel cell electric vehicles (FCEV), etc.

Unlike conventional vehicles with general internal combustion engines, the electrified vehicle includes the driving motor that provides the power required for driving. In particular, the hybrid electric vehicle uses two power sources, i.e., the engine and the motor, to provide power and torque, which are optimized based on how the engine and the motor are harmoniously operated during a driving process.

The hybrid electric vehicle has conventionally employed a combination between the driving motor and a naturally aspirated engine, but has recently employed a combination of the driving motor and an engine with a supercharger for downsizing. The supercharger using exhaust gas is called a turbocharger, and the engine with such a turbocharger is often referred to as a turbo engine.

The turbo engine provides the advantage of increased power output compared to engines with cylinders of equivalent volume, by combustion chamber via the supplying compressed air to a turbocharger, but the turbo engine needs to increase the turbocharger's boost pressure to sufficiently compress air and generate the high power. However, when the high power is suddenly required, a phenomenon that the power output is delayed until the boost pressure is increased, i.e., a turbo lag phenomenon occurs.

The foregoing matters described as the related art are only for enhancing the understanding of the background of the disclosure and should not be taken as an acknowledgement that they are the prior art already known to a person having ordinary skill in the art.

### SUMMARY

The disclosure has been conceived to solve the foregoing problems, and an aspect of the disclosure is to provide a hybrid electric vehicle and a control method thereof, in which turbo lag of an engine with a supercharger is corrected when high power is suddenly required.

It should be noted that aspects of the disclosure are not limited to the above-mentioned aspect, and other aspects of the disclosure should be apparent to those having ordinary skill in the art from the following descriptions.

According to an embodiment of the disclosure, a hybrid electric vehicle includes an engine equipped with a supercharger using exhaust gas; a driving motor; and a controller configured to determine whether entry into an acceleration state accompanied by turbo lag of the engine is expected while the engine is operating. The controller is further configured to: increase a boost pressure of the supercharger prior to entering the acceleration state when the entry into the acceleration state is expected, and control a torque of the driving motor to offset an increased engine torque of the engine that is increased to increase the boost pressure.

In an embodiment, the controller may be configured to collect at least one piece of information from among state information, driving information and forward road information of the vehicle, and determine whether the entry into the acceleration state is expected, based on the at least one piece of collected information.

In an embodiment, the controller may be configured to collect the at least one piece of information, among the state information, the driving information and the road information, through at least one of a sensor or a navigation device provided in the vehicle.

In an embodiment, the controller may be configured to determine whether a launch control function is activated based on the at least one piece of collected information, and when the launch control function is activated, the controller is configured to determine that the entry into the acceleration state is expected.

In an embodiment, the controller may be configured to determine whether the vehicle is coasting based on the at least one piece of collected information. When a number of acceleration requests for a certain period of time is greater than a reference number of times, or when a slope or curvature of a road in front of the vehicle is greater than a reference value while the vehicle is coasting, the controller is configured to determine that the entry into the acceleration state is expected.

In an embodiment, the hybrid electric vehicle may further include an engine clutch that selectively connects the engine and the driving motor. In particular, when the entry into the acceleration state is expected, the controller may be configured to control the engine to maintain the operation of the engine or control the engine clutch to maintain engagement of the engine clutch.

In an embodiment, the controller may be configured to determine a predetermined target boost pressure when the entry into the acceleration state is expected, and control the engine to increase the engine torque of the engine so that the boost pressure of the supercharger can reach the predetermined target boost pressure prior to entering the acceleration state.

In an embodiment, the predetermined target boost pressure may be set to have different target boost pressures based on whether the acceleration state is transient or sustained.

In an embodiment, the controller may be configured to: determine the increased engine torque of the engine to increase the boost pressure, and an anti-phase torque having a phase opposite to a phase of the increased engine torque. The controller is further configured to control the torque of the driving motor based on the determined anti-phase torque to offset the increased engine torque.

Further, according to an embodiment of the disclosure, a control method of a hybrid electric vehicle may include: determining whether entry into an acceleration state accompanied by turbo lag of an engine with a supercharger is expected while the engine operates; increasing a boost pressure of the supercharger prior to the entry into the acceleration state based on determination that the entry into the acceleration state is expected; and controlling a torque of a driving motor to offset an increased engine torque of the engine that is increased to increase the boost pressure.

In an embodiment, determining whether entry into the acceleration state is expected may include: collecting at least one piece of information from among state information, driving information and road information of the vehicle; and determining whether the entry into the acceleration state is expected, based on the at least one piece of collected information.

In an embodiment, collecting the at least one piece of information may include collecting at least one piece of information among the state information, the driving information and the road information through at least one of a sensor or a navigation device provided in the vehicle

In an embodiment, determining whether entry into the acceleration state is expected may include: determining whether a launch control function is activated based on the at least one piece of collected information; and determining that the entry into the acceleration state is expected based on the activated launch control function.

In an embodiment, determining whether entry into the acceleration state is expected may include: determining whether the vehicle is coasting based on the at least one piece of collected information; and determining that the entry into the acceleration state is expected based on that a number of acceleration requests for a certain period of time is greater than a reference number of times or a slope or curvature of a road in front of the vehicle is greater than a reference value during a coasting state of the vehicle.

In an embodiment, the control method may further include, before increasing the boost pressure, controlling the engine to maintain operation of the engine or controlling an engine clutch to maintain engagement of the engine clutch based on determination that the entry into the acceleration state is expected.

In an embodiment, increasing the boost pressure may include: determining a preset or predetermined target boost pressure based on that the entry into the acceleration state is expected; and increasing an engine torque of the engine until the boost pressure of the supercharger reaches the predetermined target boost pressure prior to the entry into the acceleration state.

In an embodiment, the predetermined target boost pressure may be set to have different target boost pressures based on whether the acceleration state is transient or sustained.

In an embodiment, controlling the torque of the driving motor may include: determining the increased engine torque of the engine to increase the boost pressure; determining an anti-phase torque having a phase opposite to a phase of the increased engine torque to offset the increased engine torque; and controlling the torque of the driving motor based on the determined anti-phase torque.

As described above, with the hybrid electric vehicle according to an embodiment of the disclosure and the control method thereof, the boost pressure is secured in advance by controlling the torque of the driving motor when the acceleration state accompanied by the turbo lag of the engine, such as launch control or the like rapid acceleration from stopping or rapid acceleration from coasting, thereby having effects on correcting the turbo lag phenomenon and improving the driving performance and acceleration response of the vehicle.

It should be noted that effects of the disclosure are not limited to those described above and other effects of the disclosure should be apparent to those having ordinary skill in the art from the following description.

### BRIEF DESCRIPTION OF THE DRAWINGS

FIG. 1 is a diagram illustrating a configuration of a power train in a hybrid electric vehicle applicable to an embodiment of the present disclosure.

FIG. 2 is a diagram showing a configuration of a control system of a hybrid electric vehicle applicable to an embodiment of the present disclosure.

FIG. 3 is a diagram illustrating controllers of a hybrid electric vehicle according to an embodiment of the present disclosure.

FIGS. 4 and 5 are diagrams illustrating changes in the engine torque due to operation of a controller according to an embodiment of the present disclosure.

FIGS. 6 and 7 are flowcharts illustrating a control method of a hybrid electric vehicle according to an embodiment of the present disclosure.

### DETAILED DESCRIPTION

In terms of describing the embodiments of the present disclosure, detailed descriptions of related art have been omitted when they may render the subject matter of the embodiments of the present disclosure unclear. In addition, the accompanying drawings are provided only for a better understanding of the embodiments of the present disclosure and are not intended to limit technical ideas of the disclosure. Therefore, it should be understood that the accompanying drawings include all modifications, equivalents and substitutions within the scope and spirit of the present disclosure.

Terms such as “first” and “second” may be used to describe various components, but the components should not be limited by the above terms. In addition, the above terms are used only for the purpose of distinguishing one component from another.

When it is described that one component is “connected” or “joined” to another component, it should be understood that the one component may be directly connected or joined to another component, but additional components may be present therebetween. However, when one component is described as being “directly connected,” or “directly coupled” to another component, it should be understood that additional components may be absent between the one component and another component.

Unless the context clearly dictates otherwise, singular forms include plural forms as well.

In the present disclosure, it should be understood that term “include” or “have” indicates that a feature, a number, a step, an operation, an element, a part, or the combination thereof described in the embodiments is present, but does not preclude a possibility of presence or addition of one or more other features, numbers, steps, operations, elements, parts or combinations thereof, in advance.

Further, terms “unit” or “controller” forming part of the names of a motor controller (MCU), a hybrid controller (HCU), etc., are merely terms that are widely used in the naming of a controller for controlling a specific function of a vehicle, and should not be construed as meaning a generic function unit. For example, each controller may include a communication device that communicates with other controllers or sensors, in order to control its own functions, a memory that stores an operating system, logic commands, and input/output information, and one or more processors that perform determination, calculation, decision, and the like, which is necessary for the control of the function that is responsible therefor. When a component, device, element, or the like of the present disclosure is described as having a purpose or performing an operation, function, or the like, the component, device, or element should be considered herein as being “configured to” meet that purpose or to perform that operation or function.

In the present disclosure, each of phrases such as “A or B”, “at least one of A, B or C” and “at least one of A, B, or C, or a combination thereof” may include any one or all possible combinations of the items listed together in the corresponding one of the phrases.

Below, embodiments of the disclosure are described in detail with reference to the accompanying drawings, in which the same or similar elements are denoted by the same reference numerals even though they are depicted in different drawings and redundant descriptions thereof are avoided.

Prior to describing a control method of a hybrid electric vehicle 100 according to embodiments of the disclosure, the structure and control system of the hybrid electric vehicle 100 applicable to the embodiments are first described.

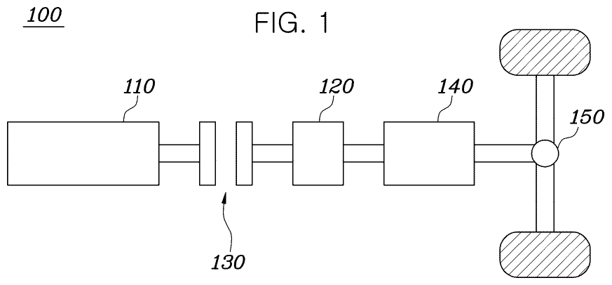

FIG. 1 is a diagram illustrating a configuration of a power train in a hybrid electric vehicle applicable to an embodiment of the disclosure.

Referring to FIG. 1, the powertrain of the hybrid electric vehicle 100 may employ a parallel type hybrid system with a driving motor (e.g., an electric motor) 120 and an engine clutch 130 mounted between an engine 110 and a transmission 140. Such a parallel type hybrid system may also be called a transmission mounted electric drive (TMED) hybrid system because the driving motor 120 is always connected to an input shaft of the transmission 140

A drive system of the hybrid electric vehicle 100 may be broadly classified into an internal combustion drive system and an electric drive system, in which an engine 110 is a representative example of the internal combustion drive system and a driving motor 120 is a representative example of the electric drive system. Further, the internal combustion drive system and the electric drive system may include not only the engine 110 and the driving motor 120, but also other components connected for operating the engine 110 and the driving motor 120, respectively. For example, the electric drive system may include not only the driving motor 120 but also an inverter, a battery, etc. for operating the driving motor 120. Further, the internal combustion drive system and the electric drive system may have a relationship therebetween, in which the operation of one system affects operation of the other system.

According to an embodiment of the present disclosure, the engine 110 may be a turbo engine with a supercharger using exhaust gas, i.e., a turbocharger.

An engine clutch 130 may be provided to selectively connect the internal combustion drive system and the electric drive system. In other words, the internal combustion drive system and the electric drive system may be connected to or disconnected from each other according to the operation of the engine clutch 130.

In the hybrid electric vehicle 100 with such a drive system, when a driver depresses an accelerator pedal after starting the vehicle (e.g., when a pedal depression amount is detected by an accelerator pedal sensor), the driving motor 120 operates with power from a battery while the engine clutch 130 is being open, and the driving power from the motor is then transmitted to wheels via a transmission 140 and a final drive (FD) 150, thereby causing the wheel 170 to move (i.e., in an electric vehicle (EV) mode). As the vehicle gradually accelerates and requires a larger driving force, an auxiliary motor (not shown) may operate to crank the engine 110.

When difference in rotational speed between the engine 110 and the driving motor 120 falls within a specific range, the engine clutch 130 is eventually engaged, causing both the engine 110 and the driving motor 120 to drive the vehicle together (i.e., transition from the EV mode to an HEV mode). When a preset engine-off condition is satisfied due to the deceleration or the like of the vehicle, the engine clutch 130 is opened and the engine 110 is stopped (i.e., transition from the HEV mode to the EV mode). During the deceleration, the battery is charged with the driving force of the wheels via the driving motor 120, which is called braking energy recovery or regenerative braking.

The auxiliary motor (not shown) may be connected to the engine 110 such that a motor shaft can be connected in series or parallel to an engine shaft of the engine 110. Therefore, the auxiliary motor (not shown) may serve as a starter motor when the engine 110 is started, recover the rotational energy of the engine 110 when the engine is turned off, and generate electric power with the driving power of the engine while the engine 110 is operating. However, this is merely an example, but not necessarily limited thereto.

In general, the transmission 140 may include a stepped transmission or a multi-plate clutch, for example, a dual clutch transmission (DCT).

FIG. 1 illustrates a configuration of the drive system of the hybrid electric vehicle applicable to the embodiments of the disclosure, and the configuration of the drive system applicable to the embodiments of the present disclosure is not limited to this exemplary configuration.

Besides the foregoing exemplary configuration, any configuration including both the engine 110 and the driving motor 120 to provide the power required for the vehicle may be applicable to the embodiments of the present disclosure regardless of a specific connection relationship or structure between the engine 110, the driving motor 120 and components connected thereto.

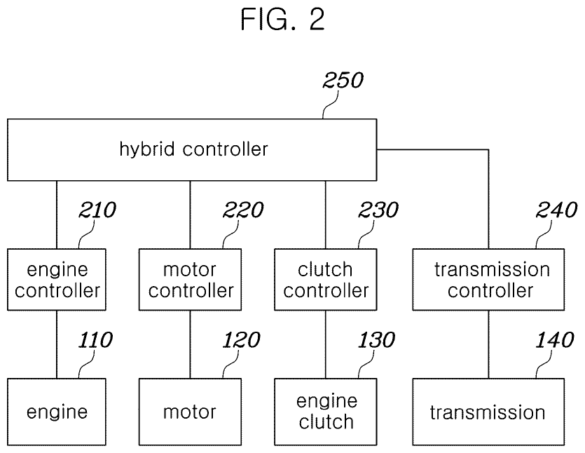

FIG. 2 is a diagram illustrating a configuration of a control system of a hybrid electric vehicle applicable to an embodiment of the present disclosure.

Referring to FIG. 2, in the hybrid electric vehicle 100 to which embodiments of the disclosure are applicable, the engine 110 may be controlled by an engine controller 210, the driving motor 120 may be controlled by a motor controller (MCU) 220, and the engine clutch 130 may be controlled by a clutch controller 230. Here, the engine controller 210 is also referred to as an engine management system (EMS). Further, the transmission 140 may be controlled by a transmission controller 240.

The controllers may be connected to their high-level controller, i.e., a hybrid controller (HCU) 250, may provide information required for engine clutch control when switching driving modes or shifting gears and/or information required for engine stop control, to the hybrid controller 250, or may perform operations based on control signals, under the control of the hybrid controller 250.

For example, the hybrid controller 250 may determine whether to switch between the EV and HEV modes or between charge depleting (CD) and charge sustaining (CS) modes, based on the operation state of the vehicle. To this end, the hybrid controller 250 may determine timing to open the engine clutch 130 and perform hydraulic control at the determined timing.

Further, the hybrid controller 250 determines the states (lock-up, slip, open, etc.) of the engine clutch 130 and controls timing to stop the fuel injection of the engine 110.

In addition, the hybrid controller 250 may transmit a torque command for controlling the torque of the driving motor 120 to the motor controller 220.

Further, the hybrid controller 250 may control the low-level controllers for determining and modifying a mode switching condition in response to mode switching control.

It should be apparent to those having ordinary skill in the art that the foregoing connections between the controllers and the described functions and divisions of the controllers are merely exemplary and should not be construed as being limited by their designations. For example, the hybrid controller 250 may be replaced by any of the other controllers, or its functions may be distributed among two or more of the other controllers.

The described configurations in FIGS. 1 and 2 are merely examples of the hybrid electric vehicle 100, and it should be obvious to those having ordinary skill in the art that the hybrid electric vehicle 100 applicable to the embodiments is not limited to this structure.

An embodiment of the present disclosure is to correct a delay in power output caused by the time required to increase the boost pressure, i.e., a turbo lag phenomenon, when high power is suddenly required for the hybrid electric vehicle 100 equipped with the turbo engine.

In an embodiment of the present addition, the hybrid electric vehicle 100 may include a controller 300 that determines whether entry into an acceleration state, accompanied by the turbo lag of the engine 110, is expected in a state that the engine 110 is operating, and the controller 300 controls the driving motor 120 to correct the turbo lag phenomenon when the entry into the acceleration state is expected.

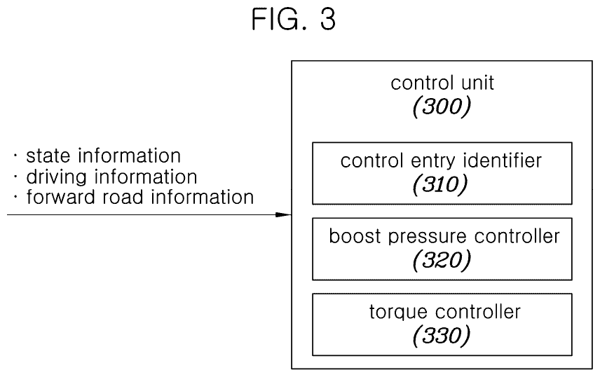

To this end, the hybrid electric vehicle 100 according to an embodiment of the disclosure and the control method thereof are described below in detail with reference to FIGS. 3 to 7.

FIG. 3 is a diagram for describing controllers in a hybrid electric vehicle according to an embodiment of the present disclosure.

Referring to FIG. 3, the controller 300 according to an embodiment of the present disclosure may include a control entry identifier 310, a boost pressure controller 320, and a torque controller 330. However, FIG. 3 mainly shows components related to the description of the embodiments of the present disclosure. It should be understood that the actual controller 300 may be implemented with additional or fewer components.

The control entry identifier 310 may determine whether or not the entry into the acceleration state accompanied by the turbo lag of the engine 110 is expected in the state that the engine 110 is operating.

In an embodiment, the control entry identifier 310 may collect at least one piece of information from among the state information and driving information, and forward road information of the hybrid electric vehicle 100. For example, the control entry identifier 310 may collect at least one piece of information among the state information, the driving information and the forward road information through at least one of a sensor or a navigation device provided in the vehicle 100.

For example, the state information may include information about the drive system including the engine 110 and the driving motor 120 provided in the vehicle 100, the driving information may include information about the driving modes of the vehicle 100 input by a driver, and the road information (e.g., forward road information) may include information about the slope or curvature of a road located in front of the vehicle. However, these are merely an example and not necessarily limited thereto.

In addition, the control entry identifier 310 may determine whether or not the entry into the acceleration state accompanied by the turbo lag of the engine 110 is expected in the state that the engine 110 is being turned on (e.g., when the engine is operating), based on at least one piece of the collected information.

The acceleration state accompanied by the turbo lag of the engine 110 may refer to a state in which acceleration is required under the condition that there is little or low load on the engine 110 while the engine 110 is operating, and the condition that there is little or low load on the engine 110 may refer to, for example a stopping condition or a coasting condition (e.g., a coasting state), in which a driver's pedal operation is not detected.

For example, the control entry identifier 310 may determine whether a launch control function is activated, based on at least one piece of the collected information, and may determine that the entry into the acceleration state is expected when it is identified that the launch control function is activated. The control entry identifier 310 may determine that the launch control function is activated when a launch control function activation signal is input by a driver's control. However, this is merely an example and not necessarily limited thereto.

As another example, the control entry identifier 310 may determine whether the vehicle 100 is coasting, based on at least one piece of the collected information, and may determine that the entry into the acceleration state is expected when a specific condition is satisfied under the condition that the vehicle 100 is coasting. In this case, the specific condition may refer to a condition of requiring the high power of the vehicle 100 in a coasting state. For example, whether the vehicle 100 requires the high power may be determined based on whether the number of acceleration requests for a certain period of time is greater than a reference number of times or whether the slope or curvature of the road in front of the vehicle is greater than a reference value.

Accordingly, the control entry identifier 310 may determine that the entry into the acceleration state is expected when the vehicle 100 is coasting and the number of acceleration requests for a certain period of time is greater than the reference number of times, and may determine that the entry into the acceleration state is expected when the vehicle 100 is coasting and the slope or curvature of the road in front of the vehicle is greater than the reference value. According to an embodiment of the disclosure, the control entry identifier 310 may determine that the entry into the acceleration state is expected when the vehicle 100 is coasting, the number of acceleration requests for a certain period of time is greater than the reference number of times, and the slope or curvature of the road in front of the vehicle is greater than the reference value. In this case, the number of acceleration requests may be identified based on a driver's input value to an accelerator pedal sensor (APS), and the slope or curvature of the road may be identified based on map information from the navigation device provided in the vehicle 100. However, this is merely an example and not necessarily limited thereto.

According to an embodiment, the control entry identifier 310 may determine whether the launch control function is activated, and further determine whether the vehicle 100 is coasting when it is determined that the launch control function is not activated. The control entry identifier 310 may respectively determine whether the launch control function is activated and whether the vehicle is coasting. In another embodiment, the control entry identifier 310 may determine them sequentially to more clearly identify whether entry into the acceleration state is expected.

In an embodiment, the control entry identifier 310 may control the engine 110 to maintain the operation of the engine 110 when the entry into the acceleration state is expected, or may control the engine clutch 130 to maintain the engagement of the engine clutch 130, which selectively connects the engine 110 and the driving motor 120. For example, the control entry identifier 310 may generate a control signal for maintaining the operation of the engine 110 or a control signal for maintaining the engagement of the engine clutch 130, and transmit the generated control signal to the engine controller 210 or the clutch controller 230, thereby controlling the engine 110 or the engine clutch 130.

According to an embodiment of the disclosure, the foregoing control for the engine 110 or the engine clutch 130 by the control entry identifier 310 may be performed before increasing the boost pressure by the boost pressure controller 320. However, this is merely an example and is not necessarily limited thereto. For example, the foregoing control for the engine 110 or the engine clutch 130 by the control entry identifier 310 may be performed at the same time as the boost pressure controller 320 increases the boost pressure.

The boost pressure controller 320 may increase the boost pressure of the supercharger (not shown) provided in the engine 110 before entering the acceleration state when the entry into the acceleration state is expected. For example, the boost pressure controller 320 may identify a preset target boost pressure (i.e., a predetermined target boost pressure) when the entry into the acceleration state is expected. In this case, the predetermined target boost pressure may refer to the boost pressure of the supercharger required for increasing the load of the engine 110 above a certain level for the entry into the acceleration state. In addition, the target boost pressure may be set to have different target boost pressures based on whether the acceleration state is transient or sustained. However, this is merely an example and is not necessarily limited thereto.

In addition, when the target boost pressure is determined, the boost pressure controller 320 may increase the engine torque of the engine 110 so that the boost pressure of the supercharger (not shown) can reach the target boost pressure prior to the entry into the acceleration state. In this way, the boost pressure controller 320 increases the engine torque to increase the boost pressure of the supercharger (not shown) before the entry into the acceleration state, so that the load on the engine 110 can be generated in advance before the entry into the acceleration state, thereby preventing a delay in the power output when entering the acceleration state.

The vehicle 100 may be in the state that the launch control function is activated while the engine 110 is turned on (i.e., when the engine operates), or may be coasting (i.e., in the coasting state). In this situation, when the load on the engine 110 is generated in advance to increase the engine torque before entering the acceleration state, unnecessary power is output, thereby causing the launch control function not to be properly implemented or the coasting driving to be canceled. In other words, the entry into the acceleration state with the engine 110 may not be performed smoothly

Therefore, when the acceleration state accompanied by the turbo lag of the engine 110 is expected, the boost pressure of the supercharger (not shown) is increased before the entry into the acceleration state, but the controller 300 according to an embodiment of the disclosure may include the torque controller 330 to solve a problem of generating the load on the engine 110, which is caused by the increase in the boost pressure.

Specifically, the torque controller 330 may control the torque of the driving motor 120 to offset the increased torque of the engine. For example, the torque controller 330 may identify the engine torque of the engine 110, which is increased to increase the boost pressure.

In addition, the torque controller 330 may determine or identify the torque required for the driving motor 120 to offset the increased engine torque. For example, the torque controller 330 may determine anti-phase torque, which has a phase opposite to that of the engine torque, as the torque required for the driving motor 120 so as to offset the increased engine torque.

In addition, the torque controller 330 may control the torque of the driving motor 120 based on the determined anti-phase torque. As the torque controller 330 controls the driving motor 120 based on the anti-phase torque having an opposite phase to the increased engine torque, the engine power may be output preemptively and, at the same time, the preemptively output engine power is suppressed by the anti-phase torque of the driving motor 120, thereby maintaining the operation state of the engine 110 in the same condition as before entering the acceleration state (e.g., a stopping state or a coasting driving state with low power) is maintained.

After controlling the torque of the driving motor 120 through the torque controller 330, the controller 300 may control each torque of the engine 110 and the driving motor 120 to follow requirement power required as the hybrid electric vehicle 100 enters the acceleration state. For example, the controller 300 may distribute the torque to each of the engine 110 and the driving motor 120 to satisfy the requirement power, and control the engine 110 and the driving motor 120 based on the distributed torque.

According to an embodiment of the present disclosure, the controller 300 may be implemented as a function within the hybrid controller 250 (e.g., part of or integrated into the hybrid controller) described with reference to FIG. 2, in terms of controlling the engine 110, the driving motor 120 and the engine clutch 130. However, this is merely an example. The controller 300 according to an embodiment of the disclosure may be implemented in various ways, such as a combination of the plurality of controllers.

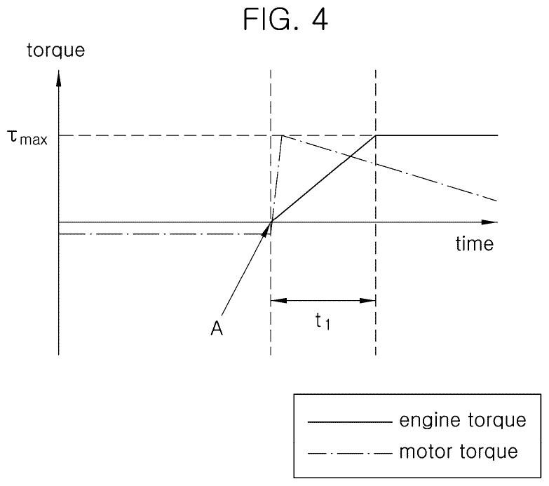

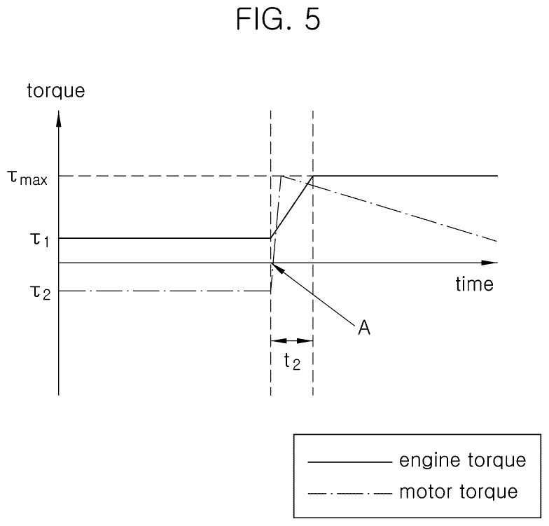

Hereinafter, the effects resulting from the operations of the controller 300 according to an embodiment of the disclosure are described with reference to FIGS. 4 and 5.

FIGS. 4 and 5 are diagrams illustrating changes in engine torque due to the operation of a controller according to an embodiment of the disclosure.

The x-axis of the graphs shown in FIGS. 4 and 5 may indicate time, the y-axis may indicate the torque, and the lines of the graphs shown in FIGS. 4 and 5 may indicate changes in torque over time.

FIG. 4 is a graph of torque change over time when the controller 300 is not operating according to an embodiment of the disclosure, FIG. 5 may be a graph of torque change over time when the controller 300 operates according to an embodiment of the disclosure.

Referring to FIG. 4, the point A may refer to a point of the entry into the acceleration state accompanied by the turbo lag of the engine 110. When reaching the point A, i.e., entering the acceleration state from the state there is little or no engine torque of the engine 110 before the point A, i.e., before the entry into the acceleration state, the motor torque of the driving motor 120 may reach the maximum torque τₘₐₓ within a short period of time as entering the acceleration state. However, it takes time t₁ for the engine torque of the engine 110 to reach the maximum torque τₘₐₓ for the entry into the acceleration state.

Referring to FIG. 5, when the entry into the acceleration state is expected, the controller 300 according to an embodiment of the disclosure may preemptively increase the boost pressure of the supercharger before entering the acceleration state. For example, the controller 300 may increase the boost pressure of the supercharger by increasing the engine torque of the engine 110 by Ti before the point A, i.e., the point of the entry into the acceleration state.

In addition, the controller 300 may control the driving motor 120 based on the anti-phase torque τ₂, the phase of which is opposite to that of the increased engine torque τ₁, to offset the increased engine torque τ₁ that is for the increase in the boost pressure. By controlling the driving motor 120 with anti-phase torque to, the increased engine torque τ₁ for the boost pressure increase may be offset with the anti-phase torque τ₂. As a result, there is little or no load on the engine 110 which may be the same condition as before the point A of FIG. 4.

In addition, the engine torque of the engine 110 is increased in advance by τ₁ before the point A so that the load can be applied to the engine 110 in advance, thereby shortening the existing time τ₁, which has taken for the engine torque of the engine 110 to reach the maximum torque τₘₐₓ due to entry into the acceleration state, into a time to at the point A, i.e., upon the entry into the acceleration state. Thus, even though there is little or no load on the engine 110, an acceleration response of the engine 110 is improved upon the entry into the acceleration state, thereby correcting the turbo lag phenomenon that the power output is delayed.

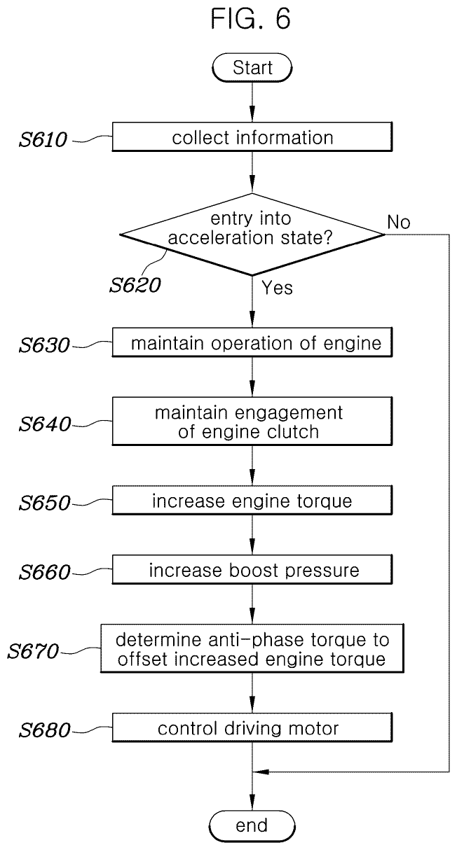

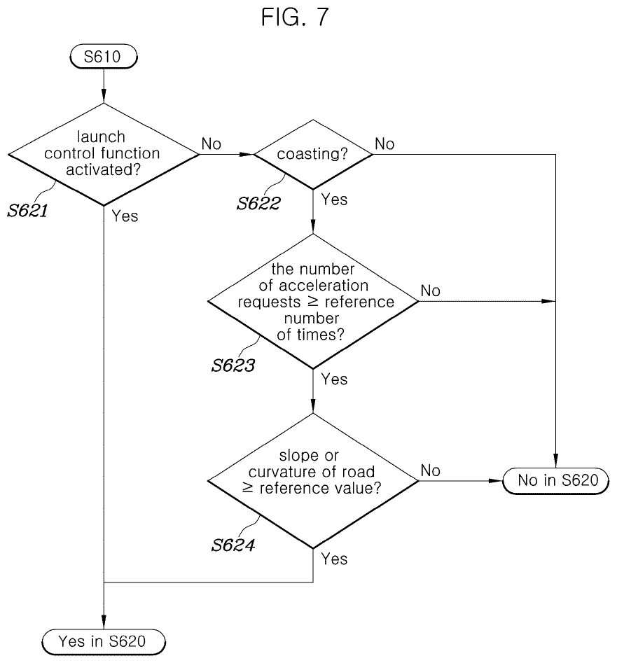

According to an embodiment of the present disclosure, a control method for the hybrid electric vehicle 100 is described with reference to FIGS. 1 to 3, and the controller 300 provided in the hybrid electric vehicle 100 is described with reference to FIGS. 6 and 7.

For ease of explanation, it is assumed that the functions of the control entry identifier 310, the boost pressure controller 320, and the torque controller 330 are integrated into the function of the controller 300.

FIGS. 6 and 7 are flowcharts for describing a control method of a hybrid electric vehicle according to an embodiment of the disclosure.

Referring to FIG. 6, the controller 300 collects at least one piece of information among the state information, the driving information and the forward road information of the vehicle 100 through at least one sensor or navigation device provided in the vehicle 100 (S610).

In addition, the controller 300 determines or identifies whether or not the entry into the acceleration state accompanied by the turbo lag of the engine 110 is expected in the state that the engine 110 is being turned on (e.g., when the engine operates) based on the collected information (in step S620). Details of step S620 are described with reference to FIG. 7.

Referring to FIG. 7, the controller 300 may determine whether the launch control function is activated based on the collected information (in step S621). When it is determined that the launch control function is activated (Yes in S621), the controller 300 may determine that the entry into the acceleration state accompanied by the turbo lag of the engine 110 is expected (Yes in S620).

When it is determined that the launch control function is not activated (No in S621), the controller 300 may determine whether the vehicle 100 is coasting (i.e., in a coasting state) based on the collected information (in step S622). In addition, when it is determined that the vehicle 100 is coasting (Yes in S622), the controller 300 determines whether the entry into the acceleration state accompanied by the turbo lag of the engine 110 is expected, based on whether certain conditions are satisfied (in steps S623, S624).

For example, when the number of acceleration requests for a certain period of time is greater than the reference number of times (Yes in S623), and the slope or curvature of the road in front of the vehicle is greater than the reference value (Yes in S624), it is determined that the entry into the acceleration state accompanied by the turbo lag of the engine 110 is expected (Yes in S620). When it is determined that the two conditions are not satisfied (i.e., No in S623, No in S624), the controller 300 determines that entry into the acceleration state accompanied by the turbo lag of the engine 110 is not expected (No in S620).

Returning back to FIG. 6, when it is determined that the entry into the acceleration state is expected (Yes in S620), the controller 300 controls the engine 110 to maintain the operation of the engine 110 before increasing the boost pressure (in step S630), and controls the engine clutch 130 to maintain the engagement of the engine clutch 130 (in step S640).

In addition, when it is determined that the entry into the acceleration state accompanied by the turbo lag of the engine 110 is expected (Yes in S620), the controller 300 controls the engine torque of the engine 110 to increase before entering the acceleration state (in step S650). For example, the controller 300 determines a preset target boost pressure when the entry into the acceleration state is expected, and performs a control to increase the boost pressure so that the boost pressure of the supercharger (not shown) can reach the preset target boost pressure before entering the acceleration state. In this way, the controller 300 increases the engine torque, thereby increasing the boost pressure of the supercharger (not shown) provided in the engine 110 (in step S660).

According to an embodiment of the disclosure, steps S630 to S640 are performed before performing the step S650, but this is merely an example. Alternatively, steps S630 to S640 may be performed together with step S650 as long as it is a point in time before the vehicle 100 enters the acceleration state.

Then, the controller 300 determines the torque of the driving motor 120 to offset the increased engine torque, which was increased to increase the boost pressure (in step S670). Specifically, the controller 300 may determine the engine torque increased to increase the boost pressure, and determine the anti-phase torque having a phase, which is opposite to a phase of the increased engine torque, to offset the increased engine torque.

In addition, the controller 300 controls the torque of the driving motor 120 based on the determined anti-phase torque (in step S680). In this way, the torque of the driving motor 120 is controlled so that the engine power can be output preemptively prior to entering the acceleration state, but change in the driving conditions before entering the acceleration state due to the engine output generation is minimized.

As described above, with the hybrid electric vehicle according to an embodiment of the disclosure and the control method thereof, the boost pressure is secured in advance by controlling the torque of the driving motor when the acceleration state accompanied by the turbo lag of the engine, such as launch control or the like rapid acceleration from stopping or rapid acceleration from coasting, thereby having effects on correcting the turbo lag phenomenon and improving the driving performance and acceleration response of the vehicle.

Although specific embodiments of the disclosure have been shown and described, it should be obvious for a person having ordinary knowledge in the art that the disclosure may be modified and changed in various ways without departing from the technical scope of the disclosure defined by the appended claims.

The disclosure may be implemented as a computer-readable code on a medium where a program is recorded. The computer-readable medium includes any types of recording devices that store data that may be read by a computer system. For example, the computer-readable medium includes a hard disk drive (HDD), a solid-state disk (SSD), a silicon disk drive (SDD), a read only memory (ROM), a random-access memory (RAM), a compact disc (CD)-ROM, a magnetic tape, a floppy disk, an optical data storage device, and the like. Therefore, the foregoing detailed description should not be construed as limiting in all respects and should be considered for illustrative purposes. The scope of the disclosure should be identified by reasonable interpretation of the appended claims, and any change within the equivalent scope of the disclosure is included in the scope of the disclosure.

What is claimed is:

1. A hybrid electric vehicle comprising:
an engine with a supercharger using exhaust gas;
a driving motor; and
a controller configured to:
determine whether entry into an acceleration state accompanied by turbo lag of the engine is expected while the engine is operating,
increase a boost pressure of the supercharger prior to the entry into the acceleration state when the entry into the acceleration state is expected, and
control a torque of the driving motor to offset an increased engine torque of the engine that is increased to increase the boost pressure.

2. The hybrid electric vehicle of claim 1, wherein the controller is configured to:
collect at least one piece of information from among state information, driving information and road information of the hybrid electric vehicle, and
determine whether the entry into the acceleration state is expected, based on the at least one piece of collected information.

3. The hybrid electric vehicle of claim 2, wherein the controller is configured to collect the at least one piece of information by at least one of a sensor or a navigation device provided in the hybrid electric vehicle.

4. The hybrid electric vehicle of claim 2, wherein the controller is configured to determine whether a launch control function is activated based on the at least one piece of collected information, and when the launch control function is activated, the controller is configured to determine that the entry into the acceleration state is expected.

5. The hybrid electric vehicle of claim 2, wherein the controller is configured to determine whether the hybrid electric vehicle is coasting based on the at least one piece of collected information, and
wherein when a number of acceleration requests for a certain period of time is greater than a reference number of times, or when a slope or curvature of a road in front of the hybrid electric vehicle is greater than a reference value while the hybrid electric vehicle is coasting, the controller is configured to determine that the entry into the acceleration state is expected.

6. The hybrid electric vehicle of claim 1, further comprising an engine clutch configured to selectively connect the engine and the driving motor,
wherein when the entry into the acceleration state is expected, the controller is configured to control the engine to maintain the operation of the engine or control the engine clutch to maintain engagement of the engine clutch.

7. The hybrid electric vehicle of claim 1, wherein the controller is configured to:
determine a predetermined target boost pressure when the entry into the acceleration state is expected, and
control the engine to generate the increased engine torque so that the boost pressure of the supercharger reaches the predetermined target boost pressure prior to entering the acceleration state.

8. The hybrid electric vehicle of claim 7, wherein the predetermined target boost pressure is set to have different target boost pressures based on whether the acceleration state is transient or sustained.

9. The hybrid electric vehicle of claim 1, wherein the controller is configured to:
determine the increased engine torque of the engine to increase the boost pressure, and an anti-phase torque having a phase opposite to a phase of the increased engine torque, and
control the torque of the driving motor based on the anti-phase torque to offset the increased engine torque.

10. A control method of a hybrid electric vehicle, comprising:
determining whether entry into an acceleration state, accompanied by turbo lag of an engine equipped with a supercharger, is expected while the engine is operating;
increasing a boost pressure of the supercharger prior to the entry into the acceleration state based on determination that the entry into the acceleration state is expected; and
controlling a torque of a driving motor to offset an increased engine torque of the engine that is increased to increase the boost pressure.

11. The control method of claim 10, wherein determining whether entry into the acceleration state is expected comprises:
collecting at least one piece of information from among state information, driving information and road information of the hybrid electric vehicle; and
determining whether the entry into the acceleration state is expected, based on the at least one piece of collected information.

12. The control method of claim 11, wherein collecting the at least one piece of information comprises: collecting the at least one piece of collected information from among the state information, the driving information and the road information via at least one of a sensor or a navigation device provided in the hybrid electric vehicle.

13. The control method of claim 11, wherein determining whether entry into the acceleration state is expected comprises:
determining whether a launch control function is activated based on the at least one piece of collected information; and
determining that the entry into the acceleration state is expected based on the activated launch control function.

14. The control method of claim 11, wherein determining whether entry into the acceleration state is expected comprises:
determining whether the hybrid electric vehicle is coasting based on the at least one piece of collected information; and
determining that the entry into the acceleration state is expected based on that a number of acceleration requests for a certain period of time is greater than a reference number of times, or a slope or curvature of a road in front of the hybrid electric vehicle is greater than a reference value during a coasting state of the hybrid electric vehicle.

15. The control method of claim 10, further comprising, before increasing the boost pressure, controlling the engine to maintain operation of the engine or controlling an engine clutch to maintain engagement of the engine clutch based on determination that the entry into the acceleration state is expected.

16. The control method of claim 10, wherein increasing the boost pressure comprises:
determining a predetermined target boost pressure based on determination that the entry into the acceleration state is expected; and
increasing an engine torque of the engine until the boost pressure of the supercharger reaches the predetermined target boost pressure prior to the entry into the acceleration state.

17. The control method of claim 16, wherein the predetermined target boost pressure is set to have different target boost pressures based on whether the acceleration state is transient or sustained.

18. The control method of claim 10, wherein controlling the torque of the driving motor comprises:
determining the increased engine torque of the engine to increase the boost pressure;
determining an anti-phase torque having a phase opposite to a phase of the increased engine torque to offset the increased engine torque; and
controlling the torque of the driving motor based on the anti-phase torque.
